(19) United States
(12) Patent Application Publication
(10) Pub. No.: US 2026/0236936 A1
(43) Pub. Date: Aug. 13, 2026

(54) PRODUCT CARBON FOOTPRINTS AS A SERVICE

(71) Applicant: HEWLETT PACKARD ENTERPRISE DEVELOPMENT LP, Spring, TX (US)

(72) Inventors: CLARK THOMAS LAUGHLIN, Houston, TX (US); Melissa Spannuth, Bozeman, MT (US); Michael Scott Bunker, Tomball, TX (US); Taylor Frances Brown, Austin, TX (US); Eduardo Bustos, Katy, TX (US); David Scott Shaffer, Houston, TX (US)

(21) Appl. No.: 19/050,948

(22) Filed: Feb. 11, 2025

(51) Int. Cl. G06Q 30/018

(52) U.S. Cl. CPC G06Q 30/018

(57) ABSTRACT

Systems and methods are provided for determining a carbon footprint for unit processes of the product identifier, including for all components and subcomponents associated with the product identifier. If all unit process calculations for all identifiers executed successfully, the system aggregates the calculated carbon footprints to the desired level of detail and returns the results to an interface.

### BACKGROUND

Many companies today focus on sustainability and reducing greenhouse gas (GHG) or carbon emissions. In response to calls from scientists, global governing bodies and companies have established net zero targets for reducing their GHG and carbon emissions. Meeting these targets requires companies to reduce the carbon footprint of their business activities, including their products and services.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates a computing component for implementing product carbon footprints as a service, in accordance with some examples described herein.

FIG. 2 is an illustrative process for determining a list of unit process carbon footprint models, in accordance with some examples described herein.

FIG. 3 is an illustrative process for determining a list of unit process for an identifier, in accordance with some examples described herein.

FIG. 4 is an illustrative process for determining whether model dependencies are met, in accordance with some examples described herein.

FIG. 5 is an illustrative process for aggregating output from unit process carbon footprint models, in accordance with some examples described herein.

FIG. 6 is an example computing component that may be used to implement various features discussed herein.

FIG. 7 is a computing component that may be used to implement examples of the disclosed technology.

The figures are not exhaustive and do not limit the present disclosure to the precise form disclosed.

### DETAILED DESCRIPTION

A company can reduce its carbon footprint of its business activities (e.g., products, services, etc.) various ways. However, before a company can reduce its carbon footprint, it should be able to accurately measure and report the carbon footprint. In determining the carbon footprint value, the company can make actionable changes to reduce the carbon footprint in future products, systems, services, and other business activities.

There are many ways for companies to estimate the carbon footprint. The least accurate method, but potentially easiest to implement, are economic input/output models based on the cost of or spend on the product. The most detailed method (and potentially the most resource intensive) is to complete a full lifecycle analysis of a product, including primary data on the emissions associated with the various unit processes that go into producing the product. A “unit process” is a set of activities to physically or virtually create a product associated with a product identifier. For example, the product may be created through manufacturing, transportation, use, or disposal/end-of-life. When the product is more complex and comprised of several components or subcomponents, the components and subcomponents may also be associated with a unit process. “Components” of a product may include a complete part of the product and “subcomponent” of the product may include a complete part of the component of the product. The components of the product may be made up of subcomponents.

Each of the unit processes of the products, components, and subcomponents may be further sub-divided. For example, the manufacturing unit process may comprise a set of materials used in the constructing the product, including the amount of aluminum or other materials that the product contains and the process to manufacture the aluminum/material. The transportation unit process may comprise a carbon footprint value to move the components within a warehouse or to other warehouses to assemble (via machinery) the final product. The use unit process may comprise a carbon footprint value to operate the final product for its intended or unintended purpose and any effects of the use in generating additional carbon footprint values. The disposal unit process may comprise a carbon footprint value to end the use of the final product and any effects of the disposal in generating additional carbon footprint values.

Carbon footprint estimation can also be conducted through an intermediate approach. The intermediate approach can involve attribute modeling, where certain features or attributes of a product are correlated with specific unit processes and emissions associated with performing those processes to create the product attributes. As an illustrative example, for a hard disk drive, the drive capacity may be relevant in determining the carbon footprint of the overall device. The manufacturing process may comprise a set of materials used in the manufacture of the device, including the amount of aluminum that the hard disk drive contains and the process to manufacture this aluminum. The process can calculate the impact associated with manufacturing processes or transportation. Similar models are constructed for other materials and processes of the hard disk drive, which can be aggregated to assess the carbon footprint of the device as a whole. The emissions associated with each process are correlated to the product attribute (e.g., hard disk drive capacity), such that for other hard disk drives, the carbon footprint can be calculated simply by knowing its capacity.

For companies with a diverse portfolio of products and services that spans many suppliers, manufacturing processes, and distribution routes, different products or even different components of a single product may use different methods to calculate their carbon footprints, including any one of the methods described above. These differences in carbon footprint calculations may be due to the different types of data available for the products. As companies drive towards greater accuracy in measuring and reporting the carbon footprint, the companies should be able to determine accurate emissions data and models in calculating the carbon footprints of their products.

Examples of the present system are configured to determine a carbon footprint value for products and services. For example, the system may receive a list of product identifiers from a user for the products and services for which a carbon footprint is requested. The product identifier can be any means of uniquely identifying a product or service, or component or subcomponent of a product, such as alphanumeric codes, part numbers, stock keeping units (SKUs), or product names. Using the product identifier, the system can retrieve a product category label, an assembly indicator, and other data associated with each product identifier from an entity data store. The product category label can identify the product type of the product or service. The assembly indicator can identify the components or subcomponents of the product. Other/second data associated with each product identifier can also be retrieved. The other/second data may be any relevant information about the product, such as name, description, weight, dimensions, price, manufacture location, composition, country of origin, list of components or subcomponents, manufacturer, or supplier.

In response to receiving the product identifier for the overall product, the system may determine the components and subcomponents of the product. For example, using the product identifier, the system can determine, for each product identifier, a list of unit processes relevant to the product identifier. Further, for each unit process of each product identifier, the system can determine a list of unit process carbon footprint models.

As an illustrative example, the product category label may be “hard disk drive” reflecting that the product is a hard disk drive. The product category of “hard disk drive” may associate various unit processes including “manufacturing,” “transportation,” “use,” or “disposal” (or “end-of-life”). For products of category “hard disk drive”, the “manufacturing” unit process may have models associated with it that calculate the carbon footprint based on, for example, data received directly from the supplier, the capacity of the hard drive, the price of the hard drive, an industry average value, or other relevant data. In some examples, the list of models for each unit process for the identifier may sort the models in an order. The order may correspond with the most accurate or otherwise most desirable model listed first, and the remaining models may be listed in descending order of accuracy or desirability (e.g., based on a calculated accuracy or desirability score). The system can generate and provide the list of unit processes each with an ordered list of unit process carbon footprint models.

In some examples, the assembly indicator may be matched to an assembly data store to create a second list of components and subcomponent identifiers of the product identifier associated with the assembly of the product. The associated data for assembly identifiers may be retrieved from the entity data store. The assembly identifiers and associated data can be added to a single data store so the number of units of each component or subcomponent can be aggregated for multiple entries. The single data store may be deduplicated/flattened to remove duplicate entries.

Using the retrieved list of unit process carbon footprint models for each unit process of each product identifier, the system can determine whether the model dependencies are met. Model dependencies may include availability of certain associated data for the identifier (e.g. hard disk capacity, product weight or dimensions) or availability of certain ancillary data (e.g. grid emissions factor for the country of operation), to name a few. If the first model dependencies are not satisfied, the system can determine whether another model is available in the ordered list of unit process models. If another/second unit process carbon footprint calculation model is available, the system can again evaluate the model dependencies and execute the model, if possible. This cycle can sequentially repeat until a model is found for which the dependencies are met and a carbon footprint is calculated, or until the ordered list of unit process models is exhausted. If no suitable unit process model is found or no unit process model executes successfully, the system can return an error.

Once the system identifies a model for which the dependencies are met, the system can execute the model to determine/calculate the carbon footprint for the unit process of the product identifier. If all unit process calculations for all identifiers executed successfully, the system can aggregate the calculated carbon footprint values to the desired level of detail and return the aggregated value to an interface accessible by the user device. If all unit processes did not execute successfully, the system can return an error to the interface.

The desired level of aggregation could be provided. For example, the carbon footprint value can be aggregated across all unit processes for each identifier, aggregating across all identifiers for each unit process, aggregating across all unit processes and identifiers to create a single product carbon footprint value, or any intermediate level or sub-division of aggregation that the user deems useful. For example, the aggregated carbon footprint value (e.g., aggregated for the product, component, subcomponents, etc.) may be provided as separate values for several of the sub-divided unit process (e.g., models that determine the carbon footprint value for manufacturing, transportation, use, or disposal/end-of-life). In another example, the aggregated carbon footprint value may be provided as separate values for several of the sub-divided product lifecycle stages (e.g., manufacturing, transportation, use, or disposal/end-of-life) or component/subcomponent lifecycle stages (e.g., manufacturing, transportation, use, or disposal/end-of-life). In another example, the aggregated carbon footprint value may be provided as separate values for several of the sub-divided corporate footprint category (e.g., groups in a corporate or business environment corresponding with a CSG® or ISO® definition).

In some examples, the aggregation of the carbon footprint value can be limited. The aggregation may be limited by a particular unit process (e.g., only manufacturing unit processes are included in the aggregation), product life cycle (e.g., only manufacturing, transportation, use, or disposal/end-of-life values are included in the aggregation), or corporate footprint category (e.g., only communications groups defined by a CSG® are included in the aggregation).

Technical improvements are realized throughout the disclosed system. For example, traditional carbon footprint models may only calculate the carbon footprint value generated for a final component of a device. The described system may iteratively consider the whole device, its components and subcomponents, and the carbon footprint values associated with the assembly processes, resulting in an accurate and iterative calculation of the distributed process. This detailed approach with ordered models can allow the system to initiate carbon emission reduction efforts while simultaneously improving the underlying data. Example use cases of the data include detailed and scalable carbon accounting, emissions forecasting (including the impact of a carbon reduction effort), project estimated emissions of new hardware designs, code optimization based on minimizing embodied carbon, and tracking the impact of component-level decisions.

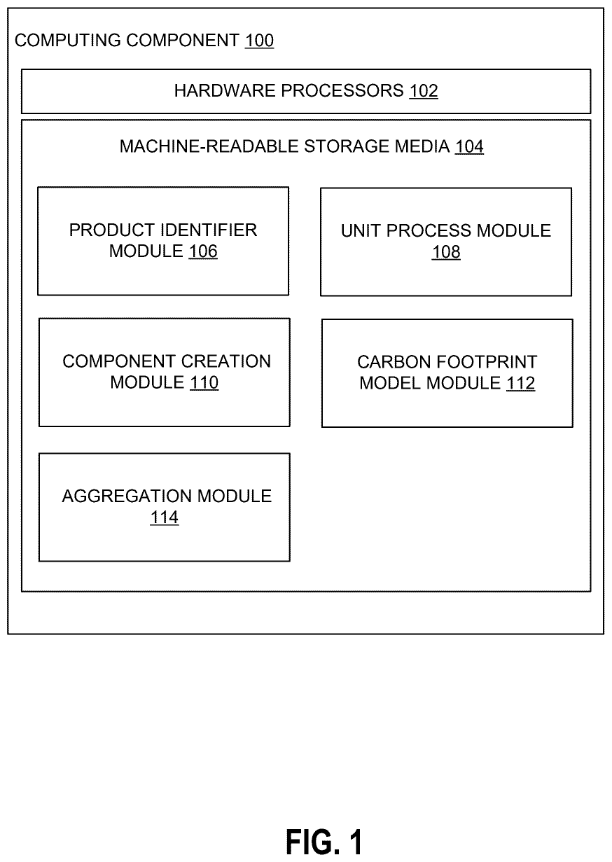

FIG. 1 illustrates a computing component for implementing product carbon footprints as a service, in accordance with some examples described herein. Computing component 100 is illustrated. Computing component 100 may be, for example, a server computer, a controller, or any other similar computing component capable of processing data.

Computing component 100 may communicate with other devices in a network, including devices at remote geographical sites, some of which may be helping to create a final product associated with a product identifier and contributing to the carbon footprint value of the corresponding product. The network may be a public or private network, such as the Internet, or other communication network to allow connectivity among various the sites. The network may include third-party telecommunication lines, such as phone lines, broadcast coaxial cable, fiber optic cables, satellite communications, cellular communications, and the like, and may include any number of intermediate network devices, such as switches, routers, gateways, servers, and/or controllers.

Computing component 100 includes hardware processor 102 and machine-readable storage medium 104. Machine-readable storage medium may comprise various modules configured with machine-readable instructions executed by processor 102, including product identifier module 106, unit process module 108, component creation module 110, carbon footprint model module 112, and aggregation module 114.

Hardware processor 102 may be one or more central processing units (CPUs), graphics processing units (GPUs), semiconductor-based microprocessors, and/or other hardware devices suitable for retrieval and execution of instructions stored in machine-readable storage medium 104. Hardware processor 102 may fetch, decode, and execute instructions to control processes or operations associated with the various modules illustrated herein. As an alternative or in addition to retrieving and executing instructions, hardware processor 102 may include one or more electronic circuits that include electronic components for performing the functionality of one or more instructions, such as a field programmable gate array (FPGA), application specific integrated circuit (ASIC), or other electronic circuits.

Machine-readable storage medium 104, may be any electronic, magnetic, optical, or other physical storage device that contains or stores executable instructions. Thus, machine-readable storage medium 104 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 104 may be a non-transitory storage medium, where the term “non-transitory” does not encompass transitory propagating signals.

Product identifier module 106 is configured to receive or determine a set of product identifiers. The product identifiers may be received from a user device (e.g., direct transmission, via website, or software application interface between computing component 100 and user device). The product identifiers may be associated with the products and services for which a carbon footprint is requested. The product identifiers may be received from a user operating a user device.

The product identifier can be any means of uniquely identifying a product or service, or component or subcomponent of a product, such as alphanumeric codes, part numbers, SKUs, or product names. In some examples, the product identifier is a part number, model, or keyword associated with the product that is used to trigger a specific unit-process. Using the product identifier, product identifier module 106 can retrieve a product category label, an assembly indicator, and other data associated with each product identifier from an entity data store. The product category label can identify the product type of the product or service. The assembly indicator can identify the components or subcomponents of the product.

In some examples, a subset of characters related to the product identifier can be removed. For example, the characters that are irrelevant to the determination of the aggregated carbon footprint value can be removed. This may include removing a brand name or model number, while keeping the characters related to a group/type of products, components, or subcomponents.

Products may be associated with a set of components and subcomponents that are combined (e.g., during manufacturing, etc.) to create the product. In some examples, product identifier module 106 is configured to match the assembly indicator to an assembly data store to create a second list of components and subcomponent identifiers of the product identifier associated with the assembly of the product. The associated data for assembly identifiers may be retrieved from a data store. The assembly identifiers and associated data can be added to the data store so the number of units of each component or subcomponent can be aggregated for multiple entries. The single data store may be deduplicated/flattened to remove duplicate entries.

Other/second data associated with each product identifier can also be retrieved. The other/second data may be any relevant information about the product, such as name, description, weight, dimensions, price, manufacture location, composition, country of origin, list of components or subcomponents, manufacturer, or supplier, to name a few. In some examples, the product identifiers can be received with a quantity of each product identifier and any operating parameters of the product. The operating parameters may define rules associated with the operation of the product (e.g., country, duration, data center efficiency values, etc.).

Product identifier module 106 is also configured to determine identifiers associated with the components and subcomponents of the product or product identifier. The components and subcomponents of the product may be determined automatically and in response to receiving the product identifier.

Unit process module 108 is configured to determine, for each product identifier, a list of unit processes relevant to the product identifier. For example, using the product identifier, unit process module 108 can determine a list of unit process carbon footprint models for each product identifier. The second set of unit processes may define activities to physically compile, combine, or otherwise create the components and subcomponents of the product associated with the product identifier. For example, the unit process for a bolt, screw, rivet, or other/secondary component used in a hard drive may involve the manufacturing and activating machinery in a supply chain to create the component. The emission factor for manufacturing the component may correspond with a standardized measurement (e.g., 1.0 kgCO₂e).

Unit process module 108 is also configured to generate an ordered list of unit process carbon footprint models for each unit process in the first set of unit processes and the second set of unit processes. In some examples, the list of models is ordered such that the most accurate or otherwise most desirable model is listed first, and the remaining models are listed in descending order of accuracy or desirability. Unit process module 108 may generate the list of unit processes each with an ordered list of unit process carbon footprint models as output.

In some examples, the ordered list of unit process carbon footprint models may remove unit processes models for carbon footprint values that are higher in a hierarchy when the models for the components or subcomponents are also included in the ordered list. This may help avoid aggregating carbon footprint values for the same subcomponent multiple times. For example, the unit process model can be identified for a product (e.g., as a first carbon footprint value) and a component of the product (e.g., as a second or “other” carbon footprint value) in an aggregated carbon footprint value. As an illustrative example, the product is a lamp with components of a base, shade, and bulb of the lamp. The unit process carbon footprint models for the product may be used or the unit process carbon footprint models for the components of the product may be used for the aggregated carbon footprint value.

The determination of using the process carbon footprint models may occur at the individual unit process level. In other words, the unit process model for manufacturing may be associated with the components, while the unit process model for the transportation may be associated with the product and the component. Each of the unit process models may be determined at the lowest level available for the product, component, and subcomponents.

Unit process module 108 (e.g., with component creation module 110) are configured to determine unit process carbon footprint models. The unit processes may define activities to physically create a product associated with a product identifier. For example, a lifecycle of the product may include “manufacturing”, “transportation”, “use”, or “end-of-life” of the components and subcomponents of the product. In another example, the lifecycle may include “manufacturing”, “transportation”, “use”, or “disposal” of the components. The manufacturing process may comprise a set of materials used in the manufacture of the product, including the amount of aluminum or other materials that the product contains and the process to manufacture the aluminum/material. The transportation may comprise a carbon footprint value to move the components within a warehouse or to other warehouses to assemble (via machinery) the final product.

Similar models may be constructed for other materials and unit processes of the hard disk drive, which may be aggregated to assess the carbon footprint of the device as a whole. The emissions associated with each process may be correlated to the product attribute (e.g., hard disk drive capacity) such that for other hard disk drives, the carbon footprint can be calculated by knowing the capacity of the hard disk drive or other product.

In some examples, the unit process carbon footprint model may comprise data on the emissions associated with the various unit processes that go into creating the product. Some examples of unit process carbon footprint model comprise attribute modeling, where certain features or attributes of a product are correlated with specific unit processes and emissions associated with performing those processes to create the product attributes.

Component creation module 110 is configured to initiate a process to physically compile, combine, or otherwise create the product associated with the product identifier. This creation process may also include the components and subcomponents of the product. For example, the process may define manufacturing rules for identifying the set of materials that form the product and physically combining the set of materials to create the product. Component creation module 110 may interact with unit process module 108 may track the carbon footprint value through each manufacturing step associated with the component creation process.

The creation process may be initiated with conceptualization, prototyping, and design review of the physical product, components, and subcomponents. In some examples, the rules for creating the product may include production planning and scheduling to move the materials to a location that has manufacturing capability to create the product, components, and subcomponents. The creation process may also include assembling the product, components, and subcomponents from the set of materials. In some examples, component creation module 110 is also configured to implement the rules for physically storing, labeling, shipping, distributing, and other steps to manufacture, transport, use, and dispose of the product.

Component creation module 110 is also configured to receive information from a third party/entity that is configured to physically compile, combine, or otherwise create the product, components, and subcomponents. The creation process may be performed externally from computing component 100 and the information/product may be transmitted from the external system to component creation module 110.

Carbon footprint model module 112 is configured to determine whether the model dependencies are met. Model dependencies may relate to data needed to execute a calculation, or processes that may need to complete before a subsequent process can begin execution (e.g., process dependencies). Carbon footprint model module 112 may use the retrieved list of unit process carbon footprint models for each unit process of each product identifier to determine whether the model dependencies are met.

Model dependencies may include determining whether certain data or associated data is available for the identifier (e.g. hard disk capacity, product weight or dimensions) or availability of certain ancillary data for the identifier (e.g. grid emissions factor for the country of operation). If the first model dependencies are not satisfied, carbon footprint model module 112 can determine whether another model is available in the ordered list of unit process models. If another unit process carbon footprint calculation model is available, carbon footprint model module 112 can again evaluate the model dependencies and execute the model, if possible. This cycle can repeat until a model is found for which the dependencies are met and a carbon footprint is calculated, or until the ordered list of unit process models is exhausted. If no suitable unit process model is found or no unit process model executes successfully, carbon footprint model module 112 can return an error (e.g., to an interface of a user device or to another component of the system).

Once carbon footprint model module 112 identifies a model for which the dependencies are met, carbon footprint model module 112 may execute the model to determine the carbon footprint for the unit process of the product identifier. Each of the unit process carbon footprint models may generate a carbon footprint value as output.

Aggregation module 114 is configured to aggregate the output from each of the unit process carbon footprint models with other/second carbon footprint values related to the product identifier. In some examples, the desired level of aggregation could be aggregating across all unit processes for each identifier, aggregating across all identifiers for each unit process, aggregating across all unit processes and identifiers to create a single product carbon footprint value, or any intermediate level or sub-division of aggregation.

As an illustrative example, if all unit process calculations for all identifiers executed successfully, aggregation module 114 aggregates the calculated carbon footprints to the desired level of detail and returns the results to an interface accessible by the user. If all unit processes did not execute successfully, aggregation module 114 can return an error (e.g., to an interface of a user device or to another component of the system). In some examples, the aggregated carbon footprint value for the corresponding product related to the product identifier is provided (e.g., to an interface of a user device or to another component of the system).

Aggregation module 114 may aggregate carbon footprint values corresponding with all components and subcomponents for the product associated with the product identifier. In some examples, the carbon footprint value may be sub-divided. In this example, the sub-division process identifies the carbon footprint value for each unit process of the components and subcomponents. The carbon footprint values from the sub-division process may be aggregated for a total carbon footprint for each type of unit process.

For example, if product P is comprised of widgets A, B, and C, where producing each of the widgets A, B, and C involves unit processes of manufacturing and transportation, then the calculation of the total carbon footprint of P=A_manufacturing+B_manufacturing+C_manufacturing+A_transportation+B_transportation+C_transportation. Various values can be sub-divided and provided to a user. For example, the manufacturing activities A_manufacturing+B_manufacturing+C_manufacturing can be determined, aggregated, and provided as a first total carbon footprint value related to the manufacturing and the transportation activities A_transportation+B_transportation+C_transportation can be determined, aggregated, and provided as a second total carbon footprint value related to the transportation.

In some examples, the carbon footprint value is stored after transmitting the value to the user (e.g., via user device, website, software application, etc.). The transmission of the carbon footprint value can initiate an audit process on generated carbon footprint values (e.g., a comparison of the carbon footprint values across similar products or component to estimate the similarity between similar types of products/components). The audit process may generate an alert to rerun the aggregation or calculation process in view of discrepancies. In some cases, the carbon footprint value is dynamically generated, transmitted to the user, and then may be deleted from the system (e.g., to recover availability of the memory for storing other data).

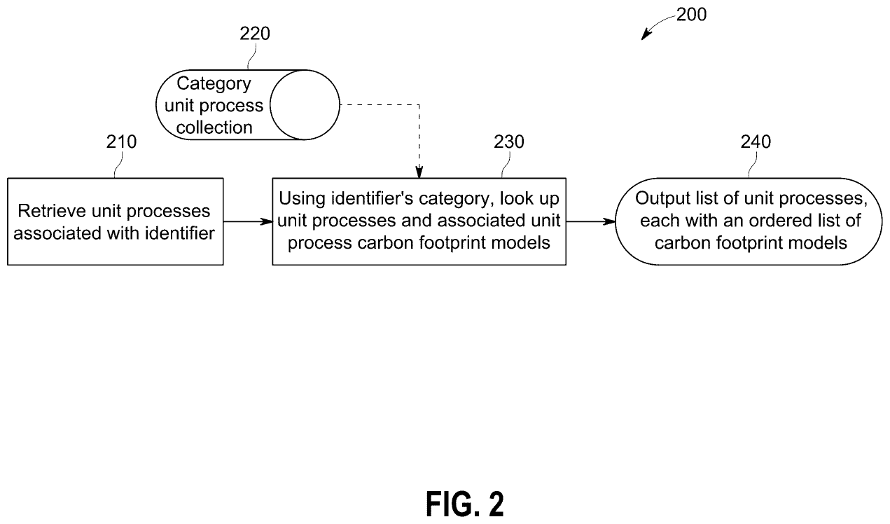

FIG. 2 is an illustrative process for determining a list of unit process carbon footprint models, in accordance with some examples described herein. In example 200, a list of unit process carbon footprint models may be determined using a computing component or system described herein, including computing component 100 in FIG. 1.

At block 210, unit processes in association with the identifier may be retrieved. For example, the process may access the product category label of the product identifier to retrieve the list of unit processes associated with products in the product category. The list of unit processes may be accessed from the category unit process collection (block 220) or other data store.

At block 230, the process may look up unit processes and associated unit process carbon footprint models. In some examples, the lookup may be performed using the identifiers category or type determination. For example, the product category label may be “hard disk drive” reflecting that the product is a hard disk drive. The product category of “hard disk drive” may have associated with it the unit processes of “manufacturing”, “transportation”, “use” or “end-of-life”. For products of category “hard disk drive”, the “manufacturing” unit process may have models associated with it that calculate the carbon footprint based on: data received directly from the supplier, the capacity of the hard drive, the price of the hard drive, an industry average value, or other relevant data.

At block 240, the process may output a list of unit processes. The list of unit processes may each comprise an ordered list of carbon footprint models. For example, the ordered list may be ordered by an accuracy score of the model. As an illustrative ordering, the most accurate or otherwise most desirable model may be listed first, and the remaining models are listed in descending order of accuracy or desirability. The list of unit processes may be provided as output for with an ordered list of unit process carbon footprint models.

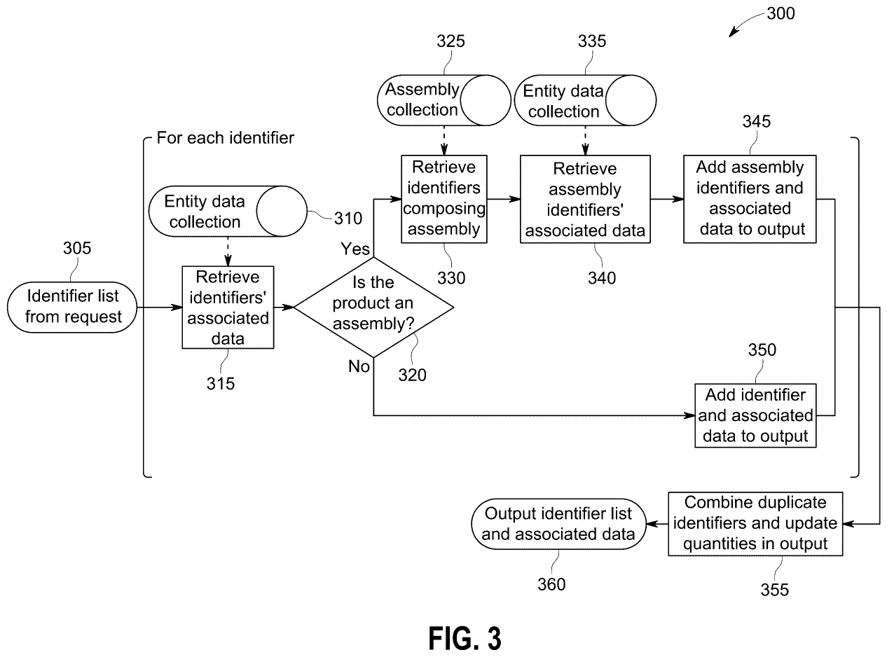

FIG. 3 is an illustrative process for determining a list of unit processes for an identifier, in accordance with some examples described herein. In example 300, a list of unit processes may be determined for an identifier in an iterative process using a computing component or system described herein, including computing component 100 in FIG. 1. In some examples, portions of the process are repeated for each identifier.

At block 305, the process may receive an identifier list. For example, the user device may provide identifiers for which it would like to identify the carbon footprint. Identifiers can be any means of uniquely identifying a product or service, or component or subcomponent of a product, such as alphanumeric codes, part numbers, SKUs, or product names.

At block 310, an entity data collection is stored in a data store. For example, the data store may comprise data associated with each identifier in the user-inputted list of identifiers. The data associated with the identifier can be any relevant information about the product, such as name, description, weight, dimensions, price, manufacture location, composition, country of origin, list of components or subcomponents, manufacturer, supplier, product category label, or other entity information associated with the product. For example, the product category label may identify the product type relevant to the carbon footprint calculation and an assembly indicator identifying the product as consisting of components or subcomponents relevant to the carbon footprint calculation.

In some examples, the product may be an “assembly” when the assembly indicator associated with the product identifier is true, active, or other flag in the dataset (e.g., as a binary value). The activation of the assembly identifier can identify that components or subcomponents are defined as being included/assembled with the assembled product.

At block 315, the process may determine identifiers in association with the data. For example, the assembly indicator may be used along with an assembly collection (block 325) to create a list of all component and subcomponent identifiers that make up the product identifier.

At block 320, the process may determine whether or not the product is an assembly (e.g., a component made up of subcomponents, or a product made up of components and subcomponents). This may include determining that the assembly indicator (e.g., flag) in the dataset is true/active. If yes, the process may proceed to 330. If not, the process may proceed to 350.

At block 330, the process may retrieve identifiers comprising the assembly. For example, the assembly identifiers' associated data is retrieved (block 340) from the entity data collection (block 335) or other data store.

At block 345, the assembly, identifiers, and associated data may be added to the output. For example, once the data are collected, the data may be provided to an interface or other process to continue with the analysis.

At block 350, the identifier and associated data may be added to the output. For example, once the data are collected, the data may be provided to an interface or other process to continue with the analysis.

At block 355, the process may combine duplicate identifiers and update quantities in the output. This may be performed in a deduplication or flattening process that removes duplicate entries and updates identifier quantities appropriately.

At block 360, the process may output the identifier list and associated data.

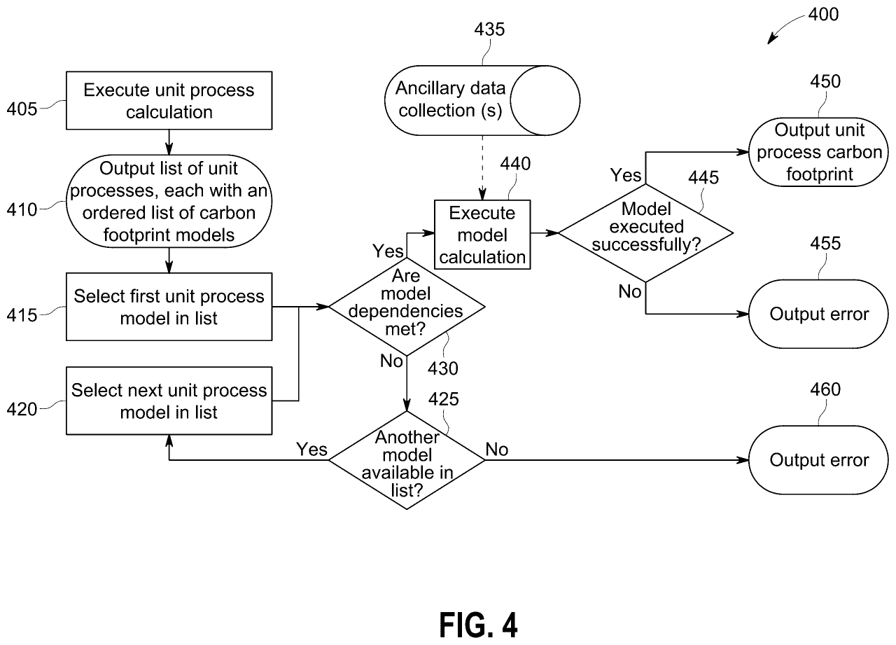

FIG. 4 is an illustrative process for determining whether model dependencies are met, in accordance with some examples described herein. In example 400, the determination whether model dependencies are met is executed using a computing component or system described herein, including computing component 100 in FIG. 1.

At block 405, the process may initiate a determination of the unit processes that are associated with the product. As discussed herein, the process can identify the unit processes that define activities to manufacture, transport, use, and dispose of a product associated with a product identifier. The command may be received and executed (e.g., via a service model or API) to create this list of unit processes. For example, the command may execute a set of instructions to access a data store and determine a list of unit processes that match the product identifier of the product, component, or subcomponent.

At block 410, the list of unit processes may be output. In some examples, each unit process of the list of unit processes may comprise an ordered list of carbon footprint models. Each unit process may correspond with a list of carbon footprint models. The list of carbon footprint models may be accessed in response to executing the unit process command.

In some examples, the list of carbon footprint models is received as output from a previous command execution (e.g., in determining the list of unit processes). The list of carbon footprint models for the unit process may be provided as input to the subsequent determination of the list of carbon footprint models for a subsequent unit process.

At block 415, the process may select a first unit process model in the list. For example, the first carbon footprint calculation model may be the numerically first model in the ordered list of unit process models for the given identifier and unit process. If the model dependencies are satisfied (block 430), the process can execute the first model (block 440), possibly using identifier associated data or other ancillary data collections (received from block 435), and use the carbon footprint value generated from the first model.

At block 420, the process may select a second unit process model in the list. For example, the second carbon footprint calculation model may be placed after the first model in the ordered list and numerically second in the list for the given identifier and unit process. If the model dependencies are satisfied (block 430), the process can execute the second model (block 440), possibly using identifier associated data or other ancillary data collections (received from block 435), and use the carbon footprint value generated from the second model.

At block 425, the process may determine whether there are additional models available in the list. If yes, the process may proceed to block 420. If no, the process may proceed to block 460. If no suitable unit process model is found or no unit process model executes successfully, the process may return an error (block 460).

In returning an error, the process may identify that a functionality of the system did not execute successfully. The error may be returned/output as an error message to an interface of a user device or to another component of the system. In some examples, the error may activate a subsequent process. The subsequent process can remove a unit process calculation (e.g., removing a subcomponent calculation from the overall product calculation) or supplement the missing/error process with a similar process (e.g., based on a comparison between the product identifiers and related unit processes).

At block 430, the process may determine whether the model dependencies are met. Model dependencies may include availability of certain associated data for the identifier (e.g., hard disk capacity, product weight or dimensions), availability of certain ancillary data (e.g., grid emissions factor for the country of operation), or other data required to execute the calculation. If yes, the process may proceed to block 440. If no, the process may proceed to block 425.

If the first model dependencies are not satisfied (block 430), the process may determine whether another model is available in the ordered list of unit process models (block 425). If another unit process carbon footprint calculation model is available, the process may again evaluate the model dependencies and execute the model if possible. This cycle can repeat until a model is found and for which the dependencies are met, causing execution of the model and calculation of the carbon footprint. Otherwise, the process may end when the ordered list of unit process models is exhausted.

At block 445, the process may determine whether the model was executed successfully (block 440). If yes, the process may proceed to block 450. If no, the process may proceed to block 455, where an error is provided as output (as illustrated with block 460).

At block 450, the process may provide the unit process carbon footprint as output. For example, when the models are executed successfully and the carbon footprint is determined, the process can return the carbon footprint for the unit process of the particular product identifier.

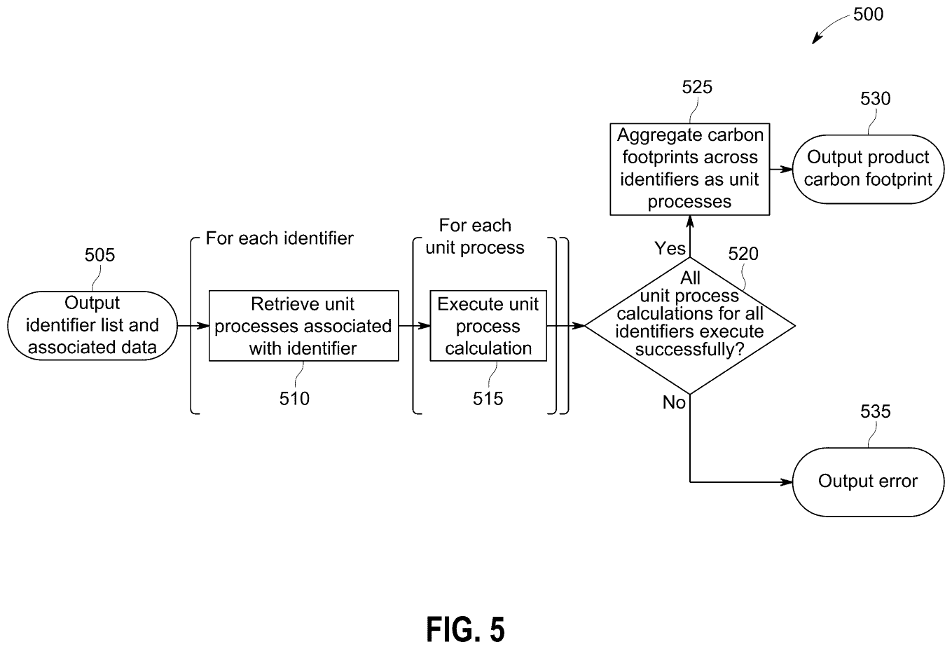

FIG. 5 is an illustrative process for aggregating output from unit process carbon footprint models, in accordance with some examples described herein. In example 500, the output from unit process carbon footprint models is aggregated/provided using a computing component or system described herein, including computing component 100 in FIG. 1.

At block 505, the process may provide an identifier list and associated data as output. The data may be received as the output from the process illustrated in FIG. 3.

At block 510, the process may retrieve unit processes associated with the identifier(s). For example, for each identifier in the list, the process first retrieves a list of unit processes and unit process models associated with the identifier.

At block 515, a unit process calculation may be executed. For example, for each unit process in that list, the process executes the unit process calculation. The process may iteratively repeat for each identifier and for each unit process associated with the identifier.

At block 520, the process may determine whether all unit process calculations for all identifiers are executed successfully. If yes, the process may proceed to block 525. If no, the process may proceed to block 535.

At block 525, the carbon footprint values may be aggregated across identifiers as unit processes. For example, if all unit process calculations for all identifiers executed successfully, the process aggregates the calculated carbon footprints to the desired level of detail and returns the results (e.g., as defined in a user profile or input from the user device). The desired level of aggregation could be aggregating across all unit processes for each identifier, aggregating across all identifiers for each unit process, aggregating across all unit processes and identifiers to create a single product carbon footprint value, or any intermediate level of aggregation that the user deems useful.

At block 530, the product carbon footprint may be provided as output. The output may include an aggregated carbon footprint value associated with each unit process carbon footprint model in the ordered list.

At block 535, the process may provide an error as output. For example, if all unit processes did not execute successfully, the process may return an error. In returning an error, the process may identify that a functionality of the system did not execute successfully. The error may be returned/output as an error message to an interface of a user device or to another component of the system.

In some examples, the error may activate a subsequent process. The subsequent process can remove a unit process calculation (e.g., removing a subcomponent calculation from the overall product calculation) or supplement the missing/error process with a similar process (e.g., based on a comparison between the product identifiers and related unit processes).

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

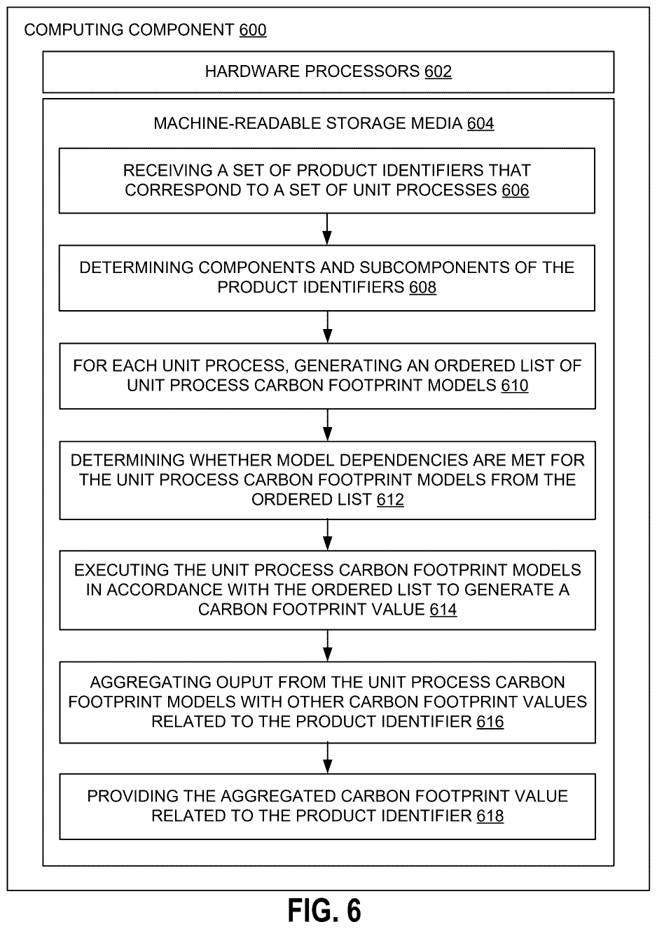

FIG. 6 illustrates a computing component that may be used to implement product carbon footprints as a service, in accordance with various examples of the disclosed technology. For example, computing component 600 may be, for example, a server computer, a controller, or any other similar computing component capable of processing data. In the example implementation of FIG. 6, the computing component 600 includes hardware processor 602 and machine-readable storage medium 604.

Hardware processor 602 may be one or more central processing units (CPUs), graphics processing units (GPUs), semiconductor-based microprocessors, and/or other hardware devices suitable for retrieval and execution of instructions stored in machine-readable storage medium 604. Hardware processor 602 may fetch, decode, and execute instructions, such as instructions 606-618, to control processes or operations for product carbon footprints as a service. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-618.

Hardware processor 602 may execute instruction 606 to receive a set of product identifiers that correspond to a set of unit processes. The product identifier can be any means of uniquely identifying a product or service.

Hardware processor 602 may execute instruction 608 to determine components and subcomponents of the product identifiers. For example, using the product identifier, the system can identify the components or subcomponents of the product. The system can also identify a product category label, an assembly indicator, and other data associated with each product identifier from an entity data store, where the product category label can identify the product type of the product or service. In some examples, the assembly indicator can identify the components or subcomponents of the product.

Hardware processor 602 may execute instruction 610 to generate an ordered list of unit process carbon footprint models. The ordered list may be generated for each unit process. For example, the unit process for the product identifier may be associated with a set of activities to physically create a product associated with a product identifier.

The order in the ordered list may correspond with the most accurate or most desirable model listed first, and the remaining models may be listed in descending order of accuracy or desirability (e.g., based on a calculated accuracy or desirability score). In some examples, the accuracy score is calculated based on the lowest level of component of the product (e.g., the material used in generating the subcomponent, the transportation to move the material from one location to another, etc.). When the unit process is calculated for the lowest level/component/subcomponent of the product, the value may be more accurate than a value that is not calculated with the lowest level/component/subcomponent of the product.

Hardware processor 602 may execute instruction 612 to determine whether model dependencies are met for the unit process carbon footprint models from the ordered list. Model dependencies may include, for example, availability of certain associated data for the identifier (e.g. hard disk capacity, product weight or dimensions) or availability of certain ancillary data (e.g. grid emissions factor for the country of operation), to name a few.

In some examples, if the first model dependencies are not satisfied, the system can determine whether another model is available in the ordered list of unit process models. If another unit process carbon footprint calculation model is available, the system can again evaluate the model dependencies and execute the model, if possible. This cycle can iteratively repeat until a model is found for which the dependencies are met and a carbon footprint is calculated, or until the ordered list of unit process models is exhausted.

Hardware processor 602 may execute instruction 614 to execute the unit process carbon footprint models in accordance with the ordered list to generate a carbon footprint value. For example, once the system identifies a model for which the dependencies are met, the system can execute the model to determine/calculate the carbon footprint for the unit process of the product identifier.

Hardware processor 602 may execute instruction 616 to aggregate output from the unit process carbon footprint models with other/secondary carbon footprint values related to the product identifier. The desired level of aggregation could be aggregating across all unit processes for each identifier, aggregating across all identifiers for each unit process, aggregating across all unit processes and identifiers to create a single product carbon footprint value, or any intermediate level or sub-division of aggregation that the user deems useful.

Hardware processor 602 may execute instruction 618 to provide the aggregated carbon footprint value related to the product identifier. For example, the system may aggregate the calculated carbon footprints to the desired level of detail and return the results to an interface accessible by the user. The aggregated carbon footprint value for the corresponding product related to the product identifier may be provided (e.g., to an interface of a user device or to another component of the system). If all unit processes did not execute successfully, the system can return an error (e.g., to an interface of a user device or to another component of the system).

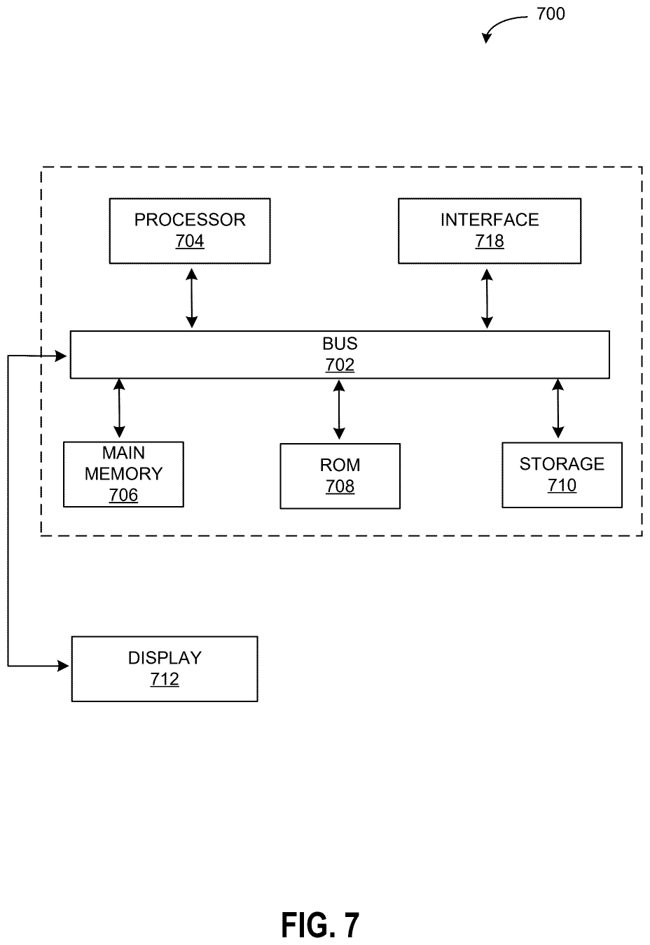

FIG. 7 depicts a block diagram of an example computer system 700 in which various examples of the disclosed technology described herein may be implemented. Computer system 700 includes bus 702 or other communication mechanism for communicating information, one or more hardware processors 704 coupled with bus 702 for processing information. Hardware processor(s) 704 may be, for example, one or more general purpose microprocessors.

Computer system 700 also includes main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

Computer system 700 further includes read only memory (ROM) 708 or other static storage device coupled to bus 702 for storing static information and instructions for processor 704. Storage device 710, such as a magnetic disk, optical disk, or USB thumb drive (Flash drive), etc., is provided and coupled to bus 702 for storing information and instructions.

Computer system 700 may be coupled via bus 702 to display 712, such as a liquid crystal display (LCD) (or touch screen), for displaying information to a computer user. The information may include, for example, a carbon footprint value.

Computer system 700 may include a user interface module to implement a GUI to provide to display 712. The user interface module may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 700 may implement the techniques described herein using customized hard-wired logic, one or more ASICs or FPGAs, firmware and/or program logic which in combination with the computer system causes or programs computer system 700 to be a special-purpose machine. According to one example of the disclosed technology, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

Computer system 700 also includes interface 718 coupled to bus 702. Interface 718 provides a two-way data communication coupling to one or more network links that are connected to one or more local networks. For example, interface 718 may be an integrated services digital network (ISDN) card, cable modem, satellite modem, or a modem to provide a data communication connection to a corresponding type of telephone line. As another example, interface 718 may be a local area network (LAN) card to provide a data communication connection to a compatible LAN (or WAN component to communicate with a WAN). Wireless links may also be implemented. In any such implementation, interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 718, which carry the digital data to and from computer system 700, are example forms of transmission media.

Computer system 700 can send messages and receive data, including program code, through the network(s), network link and interface 718. In the Internet example, a server might transmit a requested code for an application program through the Internet, the ISP, the local network and interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

1. A computer-implemented method comprising:
receiving a set of product identifiers, wherein each product identifier of the set of product identifiers corresponds with a first set of unit processes, wherein the first set of unit processes define a first activity of a product associated with a product identifier, and wherein the first activity is at least one of a manufacture, transport, use, or disposal of the product;
determining components and subcomponents of each product identifier of the set of product identifiers, wherein each of the components and subcomponents corresponds with a second set of unit processes, wherein the second set of unit processes define a second activity of components and subcomponents of the product associated with the product identifier, and wherein the second activity is at least one of a manufacture, transport, use, or disposal of the components and subcomponents of the product;
for each product identifier, adding associated data and identifiers of the components and subcomponents to a single data store to aggregate the number of units of each of the components and subcomponents;
deduplicating and flattening the single data store to remove at least one of duplicate associated data or duplicate identifiers in the single data store;
for each unit process in the first set of unit processes or the second set of unit processes, generating an ordered list of unit process carbon footprint models, wherein the ordered list of unit process carbon footprint models excludes unit process carbon footprint models associated with carbon footprint values that are higher in a hierarchy when the unit process carbon footprint models for the components and the subcomponents are also included in the ordered list;
determining whether model dependencies are met for each unit process carbon footprint model from the ordered list;
in response to determining that model dependencies are met for a first unit process carbon footprint model, executing the first unit process carbon footprint model from the ordered list, the first unit process carbon footprint model generating a first carbon footprint value;
iteratively executing subsequent unit process carbon footprint models where model dependencies are met to generate second carbon footprint values;
aggregating the first carbon footprint value with the second carbon footprint values to generate an aggregated carbon footprint value;
providing the aggregated carbon footprint value for the corresponding product related to the product identifier;
storing the aggregated carbon footprint value;
initiating an audit process on the stored aggregated carbon footprint value; and
in response to no suitable unit process model being identified or in response to at least one unit process carbon footprint model unsuccessfully executing, returning an error, the returning of the error initiating removal of the at least one unit process calculation from an overall calculation for the product.

2. The computer-implemented method of claim 1, wherein the aggregated carbon footprint value is provided as a sub-divided unit process.

3. The computer-implemented method of claim 1, wherein the aggregated carbon footprint value is sub-divided per product lifecycle stage.

4. The computer-implemented method of claim 1, wherein the aggregated carbon footprint value is sub-divided per corporate footprint category.

5. The computer-implemented method of claim 1, further comprising:
determining whether model dependencies are met for the second set of unit processes associated with the components and subcomponents of each product identifier;
iteratively executing unit process carbon footprint models associated with the second set of unit processes to generate an aggregated third carbon footprint value; and
providing the aggregated third carbon footprint value for the corresponding product related to the product identifier, wherein the aggregated third carbon footprint value is provided separately from the aggregated carbon footprint value.

6. The computer-implemented method of claim 1, further comprising:
deduplicating and aggregating the carbon footprint values related to the product identifier.

7. The computer-implemented method of claim 1, further comprising:
removing a subset of characters related to the product identifier.

8. The computer-implemented method of claim 1, further comprising:
in response to the model dependencies not being met for the unit process carbon footprint model, determining a second unit process carbon footprint model in the ordered list of unit process carbon footprint models.

9. The computer-implemented method of claim 1, wherein the determination whether the dependencies are met for the model are determined sequentially from the ordered list of unit process models.

10. The computer-implemented method of claim 1, wherein the product identifier comprises alphanumeric codes, part numbers, stock keeping units (SKUs), models, serial numbers, or product names of the product.

11. The computer-implemented method of claim 1,
wherein the audit process generates an alert to rerun the aggregating of the first carbon footprint value with the second carbon footprint values in view of discrepancies.

12. The computer-implemented method of claim 1, wherein the first set of unit processes correspond with transporting a final product to a location and the second set of unit processes correspond with transporting components of the final product to the location to assemble the final product.

13. The computer-implemented method of claim 1, wherein the first set of unit processes correspond with use of a final product and the second set of unit processes correspond with use of components of the final product.

14. The computer-implemented method of claim 1, wherein the first set of unit processes correspond with disposal of a final product and the second set of unit processes correspond with disposal of components of the final product.

15. The computer-implemented method of claim 1, wherein the first set of unit processes correspond with manufacturing a final product and the second set of unit processes correspond with assembling the final product using components of the final product.

16. The computer-implemented method of claim 1, further comprising:
receiving, for the set of product identifiers, quantity and operating parameters associated with the product, wherein the operating parameters define rules associated with operation of the product comprising country, duration, and data center efficiency values.

17. A server comprising:
a memory storing instructions; and
a processor communicatively coupled to the memory and configured to execute the instructions to:
determine components and subcomponents of a set of product identifiers, wherein each of the components and subcomponents corresponds with a set of unit processes associated with a product identifier in the set of product identifiers;
for each product identifier, add associated data and identifiers of the components and subcomponents to a single data store to facilitate aggregation of the number of units of each of the components and subcomponents;
deduplicate and flatten the single data store to remove at least one of duplicate associated data or duplicate identifiers in the single data store;
for each unit process in the set of unit processes, generate an ordered list of unit process carbon footprint models, wherein the ordered list of unit process carbon footprint models excludes unit process carbon footprint models associated with carbon footprint values that are higher in a hierarchy when the unit process carbon footprint models for the components and the subcomponents are also included in the ordered list;
determine whether model dependencies are met for each unit process carbon footprint model from the ordered list;
in response to determining that model dependencies are met for a first unit process carbon footprint model, execute the first unit process carbon footprint model from the ordered list, the first unit process carbon footprint model generating a first carbon footprint value;
iteratively execute subsequent unit process carbon footprint models where model dependencies are met to generate additional carbon footprint value;
aggregate the first carbon footprint value with the additional carbon footprint values to generate an aggregated carbon footprint value;
provide the aggregated carbon footprint value for the corresponding product related to the product identifier;
store the aggregated carbon footprint value;
initiate an audit process on the stored aggregated carbon footprint value; and
in response to no suitable unit process model being identified or in response to at least one unit process carbon footprint model unsuccessfully executing, return an error that initiates removal of the at least one unit process calculation from an overall calculation for the product.

18. The server of claim 17, wherein the aggregated carbon footprint value is provided as a sub-divided unit process.

19. The server of claim 17, wherein the aggregated carbon footprint value is sub-divided per product lifecycle stage.

20. The server of claim 17, wherein the aggregated carbon footprint value is sub-divided per corporate footprint category.
